(19) United States
(12) Patent Application Publication
(10) Pub. No.: US 2017/0359780 A1
(43) Pub. Date: Dec. 14, 2017

(54) Device, System, and Method for Adaptive Monitoring to Optimize Power Consumption

(71) Applicant: APPLE INC., Cupertino, CA (US)

(72) Inventors: Zhu JI, Cupertino, CA (US); Beibei WANG, Cupertino, CA (US); Johnson 0. SEBENI, Cupertino, CA (US)

(21) Appl. No.: 15/179,010

(22) Filed: Jun. 10, 2016

(51) Int. Cl. H04W 52/02; H04L 12/26; H04W 76/04; H04W 72/04; H04W 52/36; H04L 5/00; H04J 11/00; H04W 88/02

(52) U.S. Cl. CPC H04W 52/0209; H04L 5/006; H04L 43/16; H04J 11/00; H04W 76/048; H04W 72/0413; H04L 5/0055; H04W 52/365; H04W 88/02

(57) ABSTRACT

A device, system, and method adaptively adjusts monitoring for opportunities. The method is performed at a user equipment (UE) configured to control an operation of a transceiver, the transceiver configured to enable the UE to establish a connection with a Long Term Evolution (LTE) network, the user equipment and the LTE network configured with and utilizing a Connected Discontinuous Reception (CDRX) functionality. The method includes receiving a response from the LTE network for an uplink transmission. When the response is an acknowledgement (ACK), the method includes determining whether a value of a network parameter associated with the connection with the LTE network satisfies a predetermined threshold. When the network parameter satisfies the predetermined threshold, the method includes omitting a monitoring opportunity to verify that the ACK is a true ACK.

### BACKGROUND INFORMATION

A user equipment (UE) may be configured to establish a connection to at least one of a plurality of different networks or types of networks to perform a variety of different functionalities via the network connection. For example, the UE may communicate with another UE through the network connection. Specifically, the communication may be a Voice over Internet Protocol (IP) (VoIP) call. Accordingly, the UE may register with an IP Multimedia Subsystem (IMS) for the VoIP functionality to be performed.

The VoIP call may be performed over different types of networks. For example, when performed over a Long Term Evolution (LTE) network, the VoIP call is referred to as a VoLTE call. When performing the VoLTE call, the UE may utilize various features offered by the connection with the LTE network. For example, the UE may utilize Discontinuous Reception (DRX), particularly Connected DRX (CDRX). The DRX and CDRX may be features of the LTE network that enable the UE to conserve power. However, other operations that are performed may interfere with the power conservation feature of the CDRX cycle. Specifically, the other operations may require a transceiver to be utilized even during opportunities for the transceiver to sleep based on the CDRX cycle.

### SUMMARY

Described herein are devices, systems, and methods for adaptive monitoring to optimize power consumption. A method may comprise, at a user equipment (UE) configured to control an operation of a transceiver, the transceiver configured to enable the UE to establish a connection with a Long Term Evolution (LTE) network, the user equipment and the LTE network configured with and utilizing a Connected Discontinuous Reception (CDRX) functionality, receiving a response from the LTE network for an uplink transmission, when the response is an acknowledgement (ACK), determining whether a value of a network parameter associated with the connection with the LTE network satisfies a predetermined threshold, and when the network parameter satisfies the predetermined threshold, omitting a monitoring opportunity to verify that the ACK is a true ACK.

Also described herein is a user equipment (“UE”) comprising a transceiver configured to enable the user equipment to establish a connection with a network, the user equipment and the network configured with and utilizing a discontinuous reception functionality, and a processor configured to control an operation of the transceiver by receiving a response from the network for an uplink transmission, when the response is an acknowledgement (ACK), determining whether a value of a network parameter associated with the connection with the network satisfies a predetermined threshold, and when the network parameter satisfies the predetermined threshold, omitting a monitoring opportunity to verify that the ACK is a true ACK.

Also described herein is an integrated circuit comprising input circuitry configured to receive a response from a Long Term Evolution (LTE) network for an uplink transmission via a connection established with the LTE network and processing circuitry configured to perform a Connected Discontinuous Reception (CDRX) functionality, wherein, when the response is an acknowledgement (ACK), the processing circuitry is configured to determine whether a value of a network parameter associated with the connection with the LTE network satisfies a predetermined threshold, and when the network parameter satisfies the predetermined threshold, the processing circuitry is configured to enter a lower power state and omit a monitoring opportunity to verify that the ACK is a true ACK.

### BRIEF DESCRIPTION OF THE DRAWINGS

FIG. 1 shows a network arrangement according to various embodiments described herein.

FIG. 2 shows a CDRX cycle used by the user equipment of FIG. 1 according to various embodiments described herein.

FIG. 3 shows a user equipment according to various embodiments described herein.

FIGS. 4A-D show monitoring schedules used by the user equipment of FIGS. 1 and 3 according to various embodiments described herein.

FIG. 5 shows a method for dynamically selecting a monitoring schedule according to various embodiments described herein.

### DETAILED DESCRIPTION

The exemplary embodiments may be further understood with reference to the following description and the related appended drawings, wherein like elements are provided with the same reference numerals. The exemplary embodiments are related to a device, system, and method for optimizing power conservation. Specifically, when a user equipment (UE) is connected to a Long Term Evolution (LTE) network, performing a Voice over LTE (VoLTE) call, and also configured with a Connected Discontinuous Reception (CDRX) functionality, the exemplary embodiments may prevent various operations by a transceiver of the UE, thereby maximizing an amount of time that the transceiver is allowed to sleep based on the CDRX functionality.

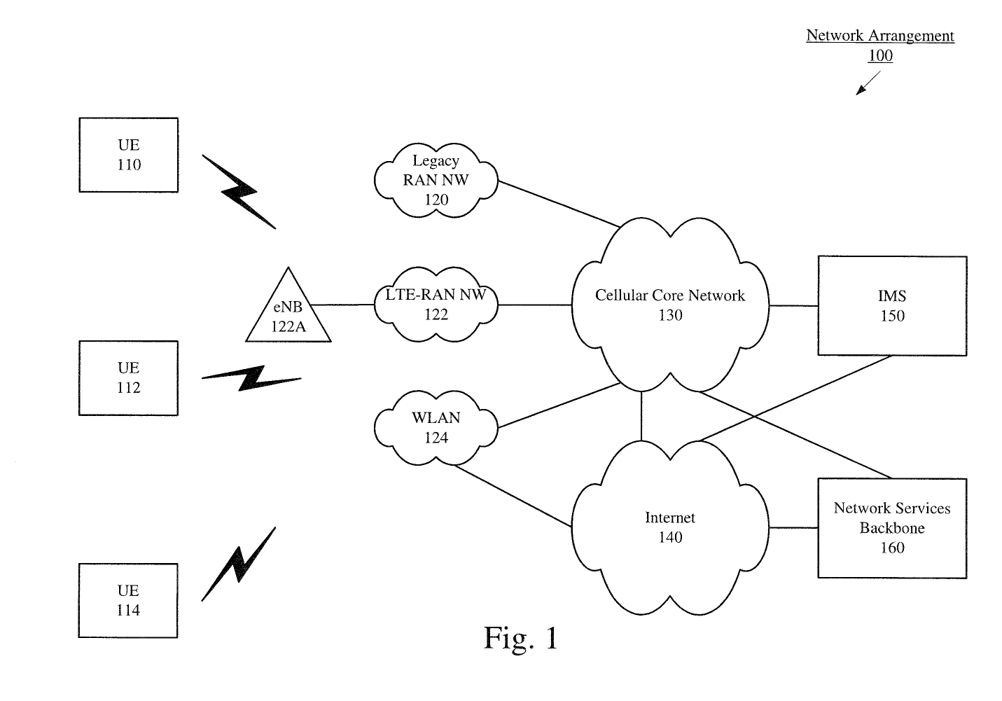

FIG. 1 shows an exemplary network arrangement 100. The exemplary network arrangement 100 includes UEs 110-114. Those skilled in the art will understand that the UEs 110-114 may be any type of electronic component that is configured to communicate via a network, e.g., mobile phones, tablet computers, desktop computers, smartphones, phablets, embedded devices, wearables, etc. It should also be understood that an actual network arrangement may include any number of UEs being used by any number of users and being associated with any number of these users where the user may be associated with one or more of the UEs. That is, the example of three (3) UEs 110-114 is only provided for illustrative purposes.

Each of the UEs 110-114 may be configured to communicate directly with one or more networks. In this example, the networks with which the UEs 110-114 may communicate are a legacy radio access network (RAN) 120, a LTE RAN (LTE-RAN) 122, and a wireless local area network (WLAN) 124. Each of the networks 120-124 is a wireless network with which the UEs 110-114 may communicate wirelessly. However, it should be understood that the UEs 110-114 may also communicate with other types of networks and may also communicate using a wired connection. With regards to the exemplary embodiments, the UEs 110-114 may establish a connection with the LTE-RAN 122 to, among other functionalities, perform VoLTE calls with other UEs. For example, the UEs 110-114 may have a LTE chipset and communicate with the LTE-RAN 122. Again, the use of three (3) networks is only exemplary and there may be any other number of networks with which the UEs 110-114 may communicate.

The legacy RAN 120 and the LTE-RAN 122 are portions of cellular networks that may be deployed by cellular providers (e.g., Verizon, AT&T, Sprint, T-Mobile, etc.). These networks 120 and 122 may include, for example, base client stations (Node Bs, eNodeBs, HeNBs, etc.) that are configured to send and receive traffic from UEs that are equipped with the appropriate cellular chip set. Examples of the legacy RAN 120 may include those networks that are generally labeled as 2G and/or 3G networks and may include circuit switched voice calls and packet switched data operations. Those skilled in the art will understand that the cellular providers may also deploy other types of networks, including further evolutions of the cellular standards, within their cellular networks (e.g., 5G network). The WLAN 124 may include any type of wireless local area network (WiFi, Hot Spot, IEEE 802.11x networks, etc.). Those skilled in the art will understand that there may be thousands, hundreds of thousands or more of different WLANs deployed in the United States alone. For example, the WLAN 124 may be the user's home network, the user's work network, a public network (e.g., at a city park, coffee shop, etc.). Generally, the WLAN 124 will include one or more access points that allow the client stations 110-114 to communicate with the WLAN 124.

As noted above, the exemplary embodiments relate to the UEs 110-114 utilizing the LTE-RAN 122 to perform VoLTE calls. However, it should be understood that the functionalities described herein may be applied to other network arrangements. For example, it is anticipated that 5G networks will implement VoIP call functionality and a discontinuous reception cycle similar to CDRX. Thus, the functionalities described herein may also be implemented for UEs that connect to future 5G networks.

In addition to the networks 120-124, the network arrangement 100 also includes a cellular core network 130 and the Internet 140. The cellular core network 130, the legacy RAN 120, and the LTE-RAN 122 may be considered a cellular network that is associated with a particular cellular provider (e.g., Verizon, AT&T, Sprint, T-Mobile, etc.). The cellular core network 130 may be considered to be the interconnected set of components that manages the operation and traffic of the cellular network. The interconnected components of the cellular core network 130 may include any number of components such as servers, switches, routers, etc. The cellular core network 130 also manages the traffic that flows between the cellular network and the Internet 140.

The network arrangement 100 also includes an IP Multimedia Subsystem (IMS) 150. The IMS 150 may be generally described as an architecture for delivering multimedia services to the UEs 110-114 using the IP protocol. The IMS 150 may include a variety of components to accomplish this task. For example, a typical IMS 150 includes a Home Subscriber Server (HSS) that stores subscription information for a user of the UEs 110-114. This subscription information is used to provide the correct multimedia services to the user such as a VoLTE call. The IMS 150 may communicate with the cellular core network 130 and the Internet 140 to provide the multimedia services to the UEs 110-114. The IMS 150 is shown in close proximity to the cellular core network 130 because the cellular provider typically implements the functionality of the IMS 150. However, it is not necessary for this to be the case such as when the IMS 150 is provided by another party.

Thus, the network arrangement 100 allows the UEs 110-114 to perform functionalities generally associated with computers and cellular networks. For example, the UEs 110-114 may perform the VoLTE calls to other parties, may browse the Internet 140 for information, may stream multimedia data to the client devices 110-114, etc.

The network arrangement 100 may also include a network services backbone 160 that is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UEs 110-114 in communication with the various networks. The network services backbone 160 may interact with the UEs 110-114 and/or the networks 120, 122, 124, 130, 140 to provide these extended functionalities.

The network services backbone 160 may be provided by any entity or a set of entities. In one example, the network services backbone 160 is provided by the supplier of one or more of the UEs 110-114. In another example, the network services backbone 160 is provided by the cellular network provider. In still a further example, the network services backbone 160 is provided by a third party unrelated to the cellular network provider or the supplier of the UEs 110-114.

The exemplary embodiments relate to the UEs 110-114 connecting to the LTE-RAN 122 via an evolved Node B (eNB) 122A. The eNB 122A may be configured with a Discontinuous Reception (DRX) functionality. More specifically, the eNB 122A may be configured with a CDRX functionality. Initially, the UEs 110-114 may establish a connection to the LTE-RAN 122. Those skilled in the art will understand that any association procedure may be performed for the UEs 110-114 to connect to the LTE-RAN 122. For example, as discussed above, the LTE-RAN 122 may be associated with a particular cellular provider where the UE 110-114 and/or the user thereof has a contract and credential information (e.g., stored on a SIM card). Upon detecting the presence of the LTE-RAN 122, the UEs 110-114 may transmit the corresponding credential information to associate with the LTE-RAN 122. More specifically, the UEs 110-114 may associate with a specific access point (e.g., the eNB 122A of the LTE-RAN 122). Thus, the UEs 110-114 that are associated with the eNB 122A may utilize the CDRX functionality when configured to perform this feature.

Those skilled in the art will understand that the CDRX functionality provides a plurality of features. For example, the CDRX functionality may relate to a synchronization of the UEs 110-114 with the eNB 122A. To properly be prepared for demodulating signals received from the eNB 122A and/or transmitting signals or data to the eNB 122A, the UE must be configured with proper settings. Specifically, properties related to the physical layer of the transceiver used to connect to the LTE-RAN 122 must be known. For example, the channel (e.g., band of frequencies) must be known for the incoming signal in order for it to be properly received. In another example, the wireless properties including timing parameters must be known for data packets to be properly transmitted. Therefore, control channel information such as physical downlink control channel (PDCCH) information including grant information, reference symbols, etc. may be received in a background operation during connection with the LTE-RAN 122. In another example, the CDRX functionality may include a cycle that defines when a transceiver of the UEs 110-114 is to sleep to conserve power. Specifically, the synchronization of the UEs 110-114 with the eNB 122A may indirectly define the sleep periods as the known active periods are determined via the control channel information.

A UE connected to the LTE-RAN 122 may utilize a predetermined manner of receiving the control channel information. Specifically, the CDRX functionality may be used. For example, in a LTE Internet protocol (IP) Multimedia Subsystem (IMS) enabled network, the UE is expected to have specified uplink transmission opportunities based upon the control channel information that is received according to the known schedule. The CDRX functionality relates to utilizing the active mode of processing and the resting mode of processing to conserve power. The CDRX functionality may include a specification or schedule according to which the control channel information is received. Therefore, when the control channel information is to be received, the UE may wake the receiver such that the receiver enters an active mode in preparation of receiving this information. The time at which the control channel information is received may be called the “onDuration” of the CDRX cycle. The onDuration relates to a number of frames over which the UE reads downlink control channel information every CDRX cycle before entering the sleep mode or using the resting mode. Thus, at all other times during the CDRX cycle, the UE may utilize the resting mode. However, as will be described in further detail below, when the UE requests an uplink grant to transmit data and subsequently transmits that data (thereby waking the transmitter which is otherwise asleep), the UE wakes the receiver to receive a response from the LTE-RAN 122 as to whether the data transmitted by the UE was received by the LTE-RAN 122 via an Acknowledgement (ACK) or a negative ACK (NACK). Accordingly, when a NACK is received, the UE wakes the transmitter to again transmit the data that was not properly received by the LTE-RAN 122. Specifically, the UE may utilize a Hybrid Automatic Repeat Request (ARQ) (HARQ) operation to ensure that an uplink transmission has properly been forwarded to the LTE-RAN 122.

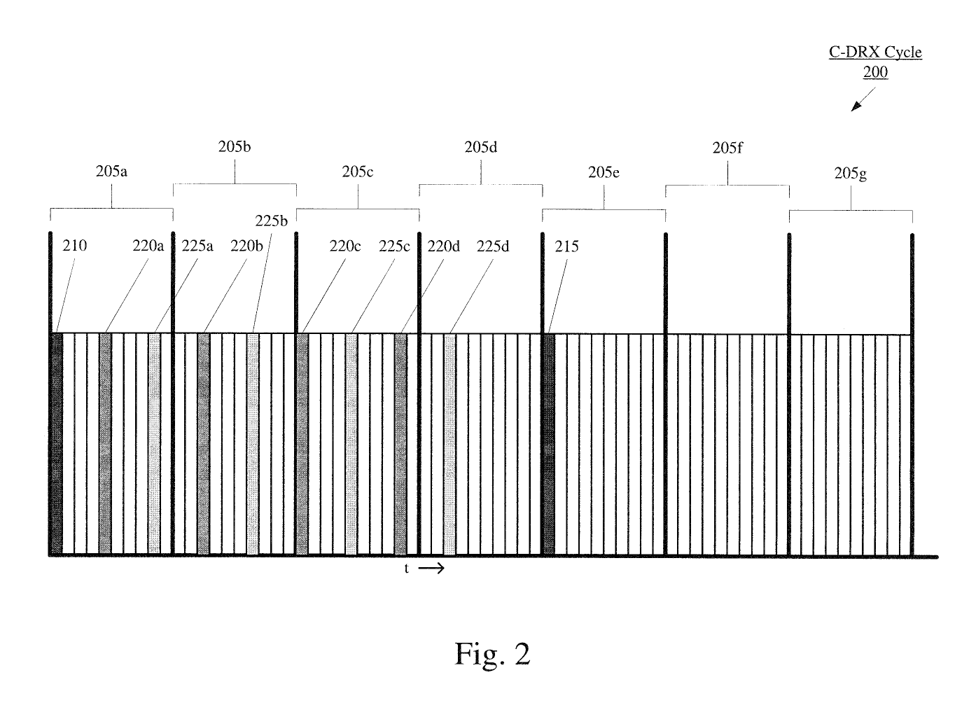

FIG. 2 shows an exemplary CDRX cycle 200 used by the UEs 110-114 of FIG. 1. The CDRX cycle 200 may have a predetermined duration such as 40 ms, 20 ms, etc. In the case that the CDRX cycle 200 is a long cycle used during a particular application of the UE such as a VoLTE call, the predetermined duration may be 40 ms (since a voice packet is often measured in 20 ms intervals such that the 40 ms duration incorporates two voice packets). Thus, only considering the receiver of the UE, at a time 0, there may be an onDuration for the control channel information to be received in which the active mode is used; subsequently, upon the onDuration lapsing, the resting mode is used; then at time 40 ms, there may be another onDuration; subsequently, the resting mode is again used until time 80 ms; etc.

The CDRX cycle 200 may be based upon a known specification or schedule. Therefore, the CDRX cycle 200 may define when transmissions are performed (based upon uplink grants) and when data is to be received (based upon downlink grants and the specification). The CDRX cycle 200 may include a plurality of frames 205a-g. Each frame 205a-g may have a duration of 10 ms. Each frame 205a-g may also include a plurality of equal duration subframes having a duration of 1 ms. Accordingly, with a predetermined cycle duration of 40 ms, a first CDRX cycle may include the frames 205a-d.

During these subframes, the control channel information may be received as indicated by the CDRX cycle 200. For example, as shown in FIG. 2, a first subframe 210 of the frame 205a (dark gray shading) may be a time when the control channel information is received. A first subframe 215 of the frame 205e (dark gray shading) may be another time when the control channel information is received as this is one cycle duration after the frame 205a (e.g., 40 ms). Accordingly, the OnDuration when the receiver of the UE is always activated to potentially receive the control channel information may be represented with the subframes 210, 215. However, it should be noted that the use of a single subframe in a given cycle (four subframes) is only exemplary. Those skilled in the art will understand that the OnDuration may include more than one consecutive subframe in which the control channel information may be received. However, those skilled in the art will appreciate that when a particular application such as the VoLTE call is being performed, the OnDuration duration may be configured with a minimal amount such that only a single subframe is used. In this manner, the periods between the OnDurations may allow the transmitter and/or receiver to be deactivated or in sleep mode to conserve power.

Also as shown in FIG. 2, the control channel information received in the first subframe 210 of the frame 205a may include PDCCH information that indicates when an uplink transmission (i.e., transmission from the UE to the LTE-RAN 122) in a physical uplink shared channel (PUSCH) may be performed. Thus, the receiver of the UE may be awake during the OnDuration. The CDRX 200 may be configured with an inactivity timer (e.g., 4 ms) which defines a duration or consecutive transmission time intervals (TTIs) during which the UE monitors the PDCCH when the uplink grant is given by the LTE-RAN 122. Thus, the inactivity timer may be represented from the first subframe 210 to a subframe 220a. Because the inactivity timer represents a monitoring period, the receiver of the UE may remain awake. It should be noted that the transmitter of the UE may be asleep during this entire duration. It should also be noted that the inactivity timer being greater than the OnDuration is only exemplary. That is, the OnDuration being 1 ms (i.e., 1 subframe) while the inactivity timer being 4 ms (i.e., 4 subframes) is only exemplary. Those skilled in the art will understand that the inactivity timer may extend beyond the OnDuration such as the exemplary embodiment shown in FIG. 2. However, those skilled in the art will also understand that the inactivity timer may be set to be within or coincide with the OnDuration so that the receiver is not required to be awake for a period longer than the OnDuration (since the OnDuration defines a time when the receiver must be awake).

As shown, the fifth subframe 220a of the frame 205a (medium gray shading) may be when the uplink grant is exercised such that data is transmitted over the PUSCH by the UE. Accordingly, the transmitter of the UE may be awake during this subframe to perform the transmission. Since the receiver of the UE is not required, the receiver may be placed in the sleep mode during this period after the OnDuration and/or the inactivity timer. The CDRX cycle 200 shows that the transmitter is only required to be awake for one subframe to perform the transmission. However, it should be noted that the transmission may take more than one subframe to complete.

Subsequently, since a transmission was made, the UE may be configured to receive a response in the form of an ACK or a NACK from the LTE-RAN 122. More specifically, the response may be received at the ninth subframe 225a of the first frame 205a. Accordingly, the receiver of the UE may be awake during this period (e.g., this subframe) to perform the reception. Since the transmitter is not required, the transmitter may be placed in the sleep mode during this period after transmitting the data in subframe 220a. The CDRX cycle 200 shows that the receiver is only required to be awake for one subframe to perform the reception. However, it should be noted that the reception may take more than one subframe to complete.

The CDRX cycle 200 further illustrates additional transmission subframes 220b, 220c, 220d and additional reception subframes 225b, 225c, 225d. The transmission subframes 220a-d and the reception subframes 225a-d may be separated with a known subframe duration. As illustrated, this known subframe duration may be 4 ms. Thus, given a subframe N (e.g., subframe 210), the transmission may be at N+4 (e.g., subframe 220a). Likewise, the ACK/NACK reception may be at N+8 (e.g., subframe 225a). This transmission and reception pattern may continue such that the transmission subframes 220b, c, d are located at N+12, N+20, and N+28, respectively, while the reception subframes 225b, c, d are located at N+16, N+24, and N+32, respectively. Those skilled in the art will understand that the control channel information may include further grants for downlink and/or uplink and the associated data transmissions or receptions may be performed at any number of locations within the frames 205a-d of a given CDRX cycle duration.

With regard to a single uplink transmission, the additional transmission subframes 220b, 220c, 220d may be used based upon the responses being received. For example, if the UE receives a NACK at the subframe 225a, the NACK may indicate that the data is to be re-transmitted. Thus, at subframe 220b, the transmission may be re-attempted. Subsequently, a response may be received at subframe 225b. This transmission attempt process may continue until the LTE-RAN 122 transmits an ACK in response to the data being transmitted from the UE. When the ACK is received, the transmitter may be deactivated as no further re-transmission may be required. However, until the ACK is received, the UE may be required to wake the transmitter for each additional subframe 220b, 220c, 220d when an attempt needs to be made.

Those skilled in the art will understand that the receiver of the UE may still be woken up during the additional subframes 225b, 225c, 225d despite the ACK being received in the subframe 225a. For example, the UE and LTE-RAN 122 may utilize the HARQ functionality or other error checking functionality when transmitting the data. This may decrease a likelihood of false positives or requests for re-transmissions. Specifically, the HARQ functionality may include error correcting information such that a transmission may be improperly received, but the HARQ data may be used to correct the data to be the intended data. For example, the VoLTE call may include talk, listen, and silence states that indicate different physical layer CDRX activities of uplink, downlink, and downlink monitoring operations, respectively. Therefore, the talk state may utilize the uplink operation to transmit data to the LTE-RAN 122.

When the LTE-RAN 122 receives the data from the UE at subframe 220a, the LTE-RAN 122 may determine whether the transmission was properly received. Performing the error check or other determination functionality, the LTE-RAN 122 transmits a response as an ACK when the data is determined to be correct while transmitting a response as a NACK when the data is determined to be incorrect. However, those skilled in the art will understand that there is still a possibility that the first transmission of the ACK is a false positive. Although mechanisms exist that improve the likelihood that false positives are decreased, such a chance is not completely eliminated. For example, the LTE-RAN 122 may transmit an ACK, even though the data was received incorrectly because of scheduling issues at the LTE-RAN 122, an example of which will be described below. The LTE-RAN 122 may therefore have transmitted an ACK at subframe 225a but may subsequently transmit a NACK at subframe 225b.

In view of the above, the HARQ functionality entails the UE to wake the receiver at each subframe marked for potential reception, namely subframes 225b, 225c, 225d. Specifically, these times may be referred to as HARQ monitoring periods. In a specific example, the UE wakes the receiver to receive the control channel information at subframe 210 in which an uplink grant is received. After receiving the control channel information and/or upon expiry of the OnDuration and/or the inactivity timer, the receiver may be placed back to sleep. At subframe 220a, the UE wakes the transmitter for the transmission to be made from the UE to the LTE-RAN 122. After the transmission, the UE may place the transmitter back to sleep. For this example, the LTE-RAN 122 may perform an initial check of the transmission and determine that it is proper. Thus, an ACK may be transmitted. At subframe 225a, the UE wakes the receiver in a first HARQ monitoring period for the reception of the ACK from the LTE-RAN 122 to be performed. The UE may place the receiver back to sleep. With the response from the LTE-RAN 122 representing a first HARQ monitoring opportunity, the LTE Specification requires that the UE always monitors one further uplink HARQ opportunity even if the ACK is received for the PUSCH transmission. Thus, the UE wakes the receiver despite the ACK being received. Specifically, this provides the LTE-RAN 122 a flexibility of scheduling by holding off the retransmission of initial transmissions of the UE to allow a further UE to use the radio resources of that subframe for uplink activities with higher priority (e.g., RACH). The HARQ functionality may also accommodate for misinterpretations by the LTE-RAN 122. For example, upon further analysis of the data, the LTE-RAN 122 may have determined that the data includes an error. Thus, the LTE-RAN 122 may transmit a NACK. Given the scheduling of events based upon the CDRX 200 and the HARQ monitoring requirement, the UE may wake the receiver at subframe 225b regardless of the reception of the ACK at subframe 225a due to these types of circumstances. Accordingly, the UE may receive the NACK at subframe 225b. Subsequently, a transmission process may again be performed at subframe 220c and a response may be received at subframe 225c.

Although the CDRX cycle 200 enables an increased power conservation compared to continuous wake states of the transmitter and receiver of the UE, the exemplary embodiments provide a mechanism that further increases the power conservation of the UE. As will be described below, the exemplary embodiments provide a network parameter monitoring functionality that provides a basis to prevent HARQ monitoring opportunities. The HARQ monitoring opportunities may lead to higher power consumption especially during use of the CDRX functionality as always monitoring the first two uplink HARQ opportunities (usually separated by 8 subframes or 8 ms for frequency division duplex (FDD) and 10 ms for time division duplex (TDD)) may not leave enough time between CDRX OnDurations for the UE to sleep (e.g., low power states of a radio frequency (RF) chain and baseband) or reach deeper sleep (e.g., lower power states of RD and baseband where more subcomponents in the baseband and RF subsystems are turned off). The network parameters being monitored may indicate an increased likelihood that a received response of ACK from the LTE-RAN 122 is a true ACK such that further HARQ monitoring opportunities may be inefficient, redundant, and an unnecessary use of the power supply of the UE.

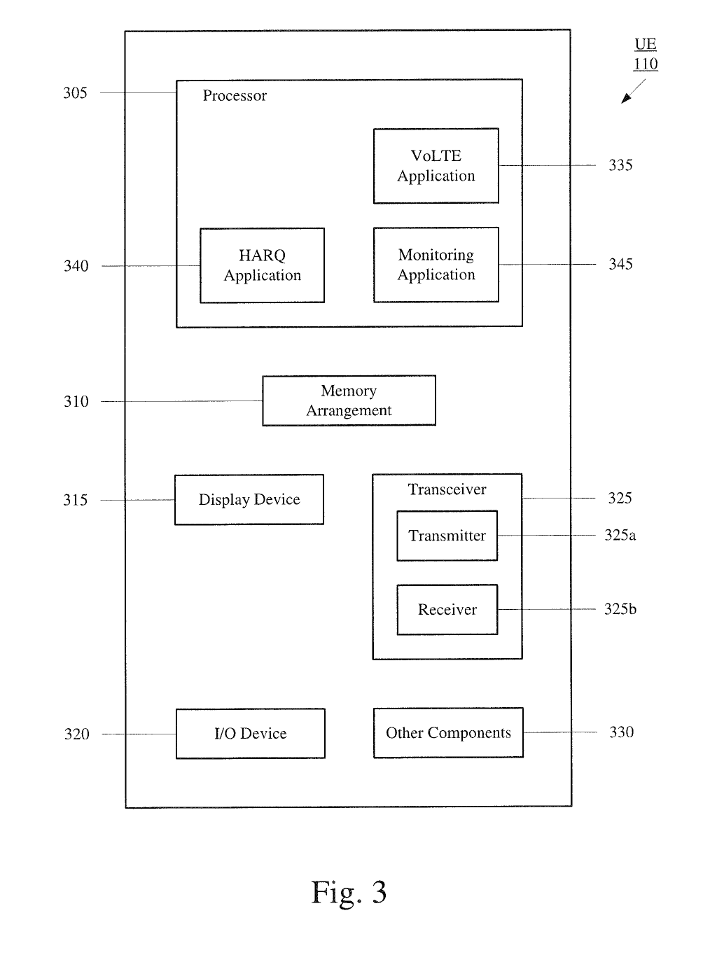

FIG. 3 shows an exemplary UE 110 of the network arrangement 100 of FIG. 1. Specifically, the UE 110 is configured to execute a plurality of applications that perform functionalities to determine a monitoring schedule. The monitoring schedule may be dynamically selected to optimize power conservation. For exemplary purposes, the UE 110 may also represent the UEs 112, 114. However, it should be noted that the other UEs 112, 114 may not necessarily be capable of performing the functionalities described below with regard to the UE 110.

The UE 110 may represent any electronic device that is configured to perform wireless functionalities and may be representative of one or more of the UEs 110-114. For example, the UE 110 may be a portable device such as a smartphone, a tablet, a phablet, a laptop, etc. In another example, the UE 110 may be a client stationary device such as a desktop terminal. The UE 110 may be configured to perform cellular and/or WiFi functionalities. The UE 110 may include a processor 305, a memory arrangement 310, a display device 315, an input/output (I/O) device 320, a transceiver arrangement 325 including a transmitter 325a and a receiver 325b, and other components 330. The other components 330 may include, for example, an audio input device, an audio output device, a battery that provides a limited power supply, a data acquisition device, ports to electrically connect the UE 110 to other electronic devices, etc.

The processor 305 may be configured to execute a plurality of applications of the UE 110. For example, the applications may include a VoLTE application 335 that enables the UE 110 to perform a VoLTE call functionality. The VoLTE call application 335 may perform all associated operations for the VoLTE call functionality to be performed including transmissions that are transmitted to and received from the LTE-RAN 122. In another example, the processor 305 may execute a HARQ application 340. As will be described in further detail below, the HARQ application 335 may be configured to perform the HARQ functionality including monitoring HARQ opportunities (e.g., via the receiver 325b), performing any retransmission, and using a forward error correction (FEC) operation. In a further example, the processor 305 may execute a monitoring application 345. As will be described in further detail below, the monitoring application 345 may be configured to perform monitoring operations related to network parameters. The network parameters may be used to determine a likelihood that a response from the LTE-RAN 122 is a true response.

It should be noted that the above noted applications each being an application (e.g., a program) executed by the processor 305 is only exemplary. The functionality associated with the applications may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. In addition, in some UEs, the functionality described for the processor 305 is split among two processors, a baseband processor and an applications processor. The exemplary embodiments may be implemented in any of these or other configurations of a UE.

The memory 310 may be a hardware component configured to store data related to operations performed by the UE 110. Specifically, the memory 310 may store data related to the various applications 335-345. For example, the VoLTE call application 335 may utilize a phone book functionality that stores contact information for other users and UEs. In another example, the memory 310 may store network parameter thresholds, monitoring schedules, etc. used by the monitoring application 345. The display device 315 may be a hardware component configured to show data to a user while the I/O device 320 may be a hardware component that enables the user to enter inputs. It should be noted that the display device 315 and the I/O device 320 may be separate components or integrated together such as a touchscreen.

The transceiver 325 may be a hardware component configured to transmit data via the transmitter 325a and receive data via the receiver 325b. The transceiver 325 may enable communication with the LTE-RAN 122 or with other electronic devices directly or indirectly through the LTE-RAN 122 to which the UE 110 is connected. The transceiver 325 may operate on a variety of different frequencies or channels (e.g., set of consecutive frequencies) that are related to the VoLTE call functionality. Thus, an antenna (not shown) coupled with the transceiver 325 may enable the transceiver 325 to operate on the LTE frequency band.

According to the exemplary embodiments, the VoLTE application 335 may be in use to perform a VoLTE call. Furthermore, the CDRX functionality may be enabled during the VoLTE call. As described above, the VoLTE call may utilize various different uplinks, downlinks, and downlink monitoring. With regard to the uplinks (i.e., transmissions made from the UE 110 to the LTE-RAN 122), the transmissions for the VoLTE call may relate to when the user of the UE 110 is talking into an audio input device. The received audio may be packaged and prepared for transmission to the LTE-RAN 122. Specifically, a request is transmitted from the UE 110 to the LTE-RAN 122 and an uplink grant may be issued for the data to be transmitted.

In performing the uplink transmissions, the HARQ application 340 may be used, particularly when an initial NACK or subsequent NACK is received for the uplink transmission. For example, the uplink grant may be used to transmit data from the UE 110 to the LTE-RAN 122. The LTE-RAN 122 may transmit a NACK indicating that the data was not entirely or properly received. The HARQ application 340 may perform its functionality to generate a retransmission for the data indicated via the NACK as not being received by the LTE-RAN 122.

As described above, the response from the LTE-RAN 122 may be an ACK or a NACK. Thus, depending on the response, the UE 110 may perform different subsequent operations. For example, using conventional approaches and as defined by the LTE Specification in which the CDRX functionality is enabled, the UE 110 that receives the ACK in response to a PUSCH may perform a further monitoring of a HARQ opportunity. This may verify that the ACK that was received is still an ACK or the LTE-RAN 122 has determined that a NACK should have been the transmission. In another example, the UE 110 that receives the NACK in response to the PUSCH must perform a retransmission as performed via the HARQ functionality (e.g., the FEC operation). The retransmission operation may also be used if, for example, the further monitoring of the HARQ opportunity after the ACK results in a NACK.

The exemplary embodiments provide a mechanism in which the process after receiving the ACK is modified to further enhance the power conservation feature associated with the CDRX. Specifically, the monitoring application 345 may monitor one or more network parameters that may indicate whether the ACK response from the LTE-RAN 122 is a true ACK. The monitoring application 345 may monitor, for example, a block error rate (BLER), a downlink signal to noise ratio (SNR), a Doppler value, an enabling/disabling of TTI bundling (TTI-B), a power headroom value, etc. The description herein relate particularly to the BLER, the downlink SNR, the Doppler value, the TTI-B, and the power headroom value. However, the exemplary embodiments may also be configured to monitor and measure other network parameters.

In monitoring these network parameters, a respective threshold value may be associated therewith. The threshold values may be automatically determined by the monitoring application 345 or may be entered by an administrator of the UE 110. The BLER relates to a ratio of erroneous data blocks to a total number of data blocks received by the UE 110. According to an exemplary embodiment, the threshold value for the BLER may be a maximum of 10%. The downlink SNR relates to a level of a desired signal to background noise for data blocks received by the UE 110. According to an exemplary embodiment, the threshold value for the downlink SNR may be a minimum of 8 dB. The Doppler value relates to a change or ratio of a signal frequency from an originating signal frequency. According to an exemplary embodiment, the threshold value for the Doppler value may be a maximum of 70 Hz. The TTI-B option relates to a feature where the HARQ functionality of a new transmission attempt every time with previous erroneous data is replaced with redundancy versions of a same set of data being transmitted in consecutive TTIs (with the LTE-RAN 122 ultimately transmitting the ACK when successfully decodes the combined data). According to an exemplary embodiment, the threshold value for the TTI-B may be that the option is disabled. The power headroom relates to a transmission power remaining for the UE 110 to use in addition to the power currently being used for a transmission. According to an exemplary embodiment, the threshold value for the power headroom may be a minimum of 3 dB. It is noted that the threshold values noted above are only exemplary. The threshold values may also be static or dynamic. For example, when the threshold values are provided by an administrator, the values may be static and defined for the monitoring application 345. In another example, when the threshold values are determined by the monitoring application 345, the threshold values may be updated through various learning algorithms and tracked for use with various network conditions, network types, etc.

The network parameters described above may be used in any combination by the monitoring application 345. For example, the BLER may provide a more direct correlation to a probability that a received ACK is a true ACK. Thus, in a first exemplary embodiment, the monitoring application 345 may utilize the BLER parameter alone in determining how the operations according to the exemplary embodiments are utilized. In another example, the downlink SNR, the Doppler value, the TTI-B, and the power headroom may provide a more indirect correlation to a probability that a received ACK is a true ACK. Thus, in a second exemplary embodiment, without the BLER value, the monitoring application 345 may utilize a combination of these network parameters. In a further example, the monitoring application 345 may utilize any combination of the network parameters with preference toward utilizing the BLER value. Those skilled in the art will appreciate that monitoring more of these network parameters may increase a confidence in the probability value associated with whether a received ACK is a true ACK.

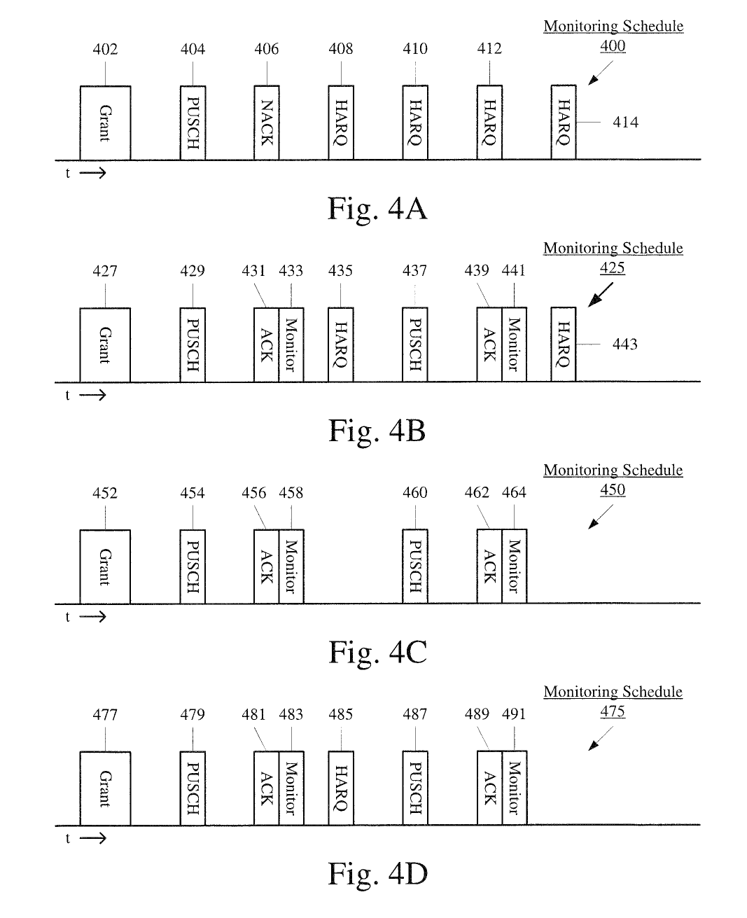

The exemplary embodiments may be utilized to determine a HARQ monitoring schedule to be used based on the response that is received from the LTE-RAN 122 for a PUSCH transmission. FIGS. 4A-C show monitoring schedules used by the UE 110 of FIG. 1. Specifically, FIG. 4A shows a monitoring schedule 400 to be used when receiving a NACK from the LTE-RAN 122 in response to a PUSCH transmission. FIG. 4B shows a monitoring schedule 425 to be used when receiving an ACK from the LTE-RAN 122 in response to a PUSCH transmission and the network parameters indicating a probability that the ACK is a true ACK less than a predetermined value. FIG. 4C shows a monitoring schedule 450 to be used when receiving an ACK from the LTE-RAN 122 in response to a PUSCH transmission and the network parameters indicating a probability that the ACK is a true ACK greater than the predetermined value.

As shown in the monitoring schedule 400 of FIG. 4A, the UE 110 may receive an uplink grant 402. As described above, the UE 110 may have transmitted a request for the uplink grant 402 and received the uplink grant 402 at a subsequent time. Thus, the PUSCH transmission 404 may be performed using the uplink grant. In response to the PUSCH transmission 404, the UE 110 may receive a NACK 406 from the LTE-RAN 122. As noted above, the NACK 406 being received may be a first HARQ monitoring opportunity. When the UE 110 receives the NACK 406, the UE 110 may perform HARQ monitoring at each further opportunity until an ACK is received. For example, HARQ opportunities 408-414 may represent times when the UE 110 may perform the HARQ functionality (e.g., receiving a NACK, performing a retransmission, receiving a response to the retransmission). It is noted that the number of HARQ opportunities is only exemplary. After the HARQ opportunity 408, the LTE-RAN 122 may transmit an ACK. Thus, as will be described below, a monitoring schedule corresponding to receiving the ACK may be performed.

As shown in the monitoring schedule 425 of FIG. 4B, the UE 110 may receive an uplink grant 427. Thus, the PUSCH transmission 429 may be performed using the uplink grant. In response to the PUSCH transmission 429, the UE 110 may receive an ACK 431 from the LTE-RAN 122. According to the exemplary embodiments, the monitoring application 345 may determine that the ACK 431 is received such that a network parameter monitoring 433 is performed. As described above, the network parameter monitoring 433 may be for any one or more network parameters such as the BLER value. The monitoring schedule 425 may specifically relate to when the monitoring application 345 determines that the network parameter monitoring 433 results in relatively poor network conditions such that the probability that the ACK is a true ACK does not have the necessary confidence. Therefore, the UE 110 may perform the further HARQ opportunity 435. If a NACK is received from the further HARQ opportunity 435, the monitoring schedule 400 may be utilized. If the ACK is verified in the HARQ opportunity 435, the UE 110 may continue to perform further PUSCH transmissions (assuming the uplink grant is issued). For example, the PUSCH transmission 437 may be performed. With substantially similar network conditions, the ACK 439 may still be received but the network parameter monitoring 441 may still correspond to performing the further HARQ opportunity 443.

As shown in the monitoring schedule 450 of FIG. 4C, the UE 110 may receive an uplink grant 452. Thus, the PUSCH transmission 454 may be performed using the uplink grant. In response to the PUSCH transmission 454, the UE 110 may receive an ACK 456 from the LTE-RAN 122. According to the exemplary embodiments, the monitoring application 345 may determine that the ACK 456 is received such that a network parameter monitoring 458 is performed. The monitoring schedule 450 may specifically relate to when the monitoring application 345 determines that the network parameter monitoring 458 results in relatively good network conditions such that the probability that the ACK is a true ACK has the necessary confidence. Therefore, the UE 110 may omit any further HARQ opportunity. By omitting the further HARQ opportunity, the UE 110 may realize more power conservation from the CDRX feature enabled. The UE 110 may continue to perform further PUSCH transmissions (assuming the uplink grant is issued). For example, the PUSCH transmission 460 may be performed. With substantially similar network conditions, the ACK 462 may still be received and the network parameter monitoring 464 may still result in omitting the further HARQ opportunity.

The exemplary embodiments may also incorporate a further HARQ monitoring schedule to be used based on an evaluation period. FIG. 4D shows a monitoring schedule 475 to be used when receiving an ACK from the LTE-RAN 122 in response to a PUSCH transmission, the network parameters indicating a probability that the ACK is a true ACK greater than the predetermined value, and the monitoring application 345 determining that the evaluation be performed. As shown in the monitoring schedule 475 of FIG. 4D, the UE 110 may receive an uplink grant 477. Thus, the PUSCH transmission 479 may be performed using the uplink grant. In response to the PUSCH transmission 479, the UE 110 may receive an ACK 481 from the LTE-RAN 122. According to the exemplary embodiments, the monitoring application 345 may determine that the ACK 481 is received such that a network parameter monitoring 483 is performed. The monitoring schedule 475 may also specifically relate to when the monitoring application 345 determines that the network parameter monitoring 483 results in relatively good network conditions such that the probability that the ACK is a true ACK has the necessary confidence. Under non-evaluation periods according to the exemplary embodiments, the UE 110 may omit any further HARQ opportunity. However, to evaluate the mechanism according to the exemplary embodiments and verify that the threshold values of the network parameters are valid, the UE 110 may perform a further HARQ opportunity 485. The UE 110 may continue to perform further PUSCH transmissions (assuming the uplink grant is issued). For example, the PUSCH transmission 487 may be performed. With substantially similar network conditions, the ACK 489 may still be received and the network parameter monitoring 491 may result in omitting the further HARQ opportunity as the PUSCH transmission 487 is not part of an evaluation. By omitting the further HARQ opportunity for non-evaluation PUSCH transmissions, the UE 110 may realize more power conservation from the CDRX feature enabled. The evaluation PUSCH transmissions may be, for example, every 20^{th} PUSCH transmission, once per second, once per two seconds, etc.

It is noted that the monitoring application 345 may perform the monitoring functionality at a variety of different times. For example, the monitoring application 345 may continuously monitor the network parameters such that the most current information is used for each PUSCH transmission. In another example, the monitoring application 345 may monitor the network parameters each time a PUSCH transmission is prepared. However, as the exemplary embodiments are associated with power conservation, in a further example, the monitoring application 345 may monitor the network parameters based on a timer. The timer may assume that the network parameters stay relatively constant throughout the period of the timer. In this manner, the monitoring application 345 is only required to perform the monitoring functionality intermittently for the power conservation to be maximized while still utilizing the exemplary embodiments. For example, the monitoring application 345 may perform the monitoring functionality every 32 or 64 uplink transmissions. The timer may also be dynamic. Specifically, when the network parameters do not satisfy the predetermined minimum probability, the timer may be a first value. When the network parameters satisfy the predetermined minimum probability, the timer may be a second value greater than the first value.

It is noted that the fourth monitoring schedule 475 and the second monitoring schedule 425 may include similar aspects. Specifically, the fourth monitoring schedule 475 and the second monitoring schedule 425 both relate to when the ACK is received in the first HARQ opportunity. However, particularly when the network parameters are measured intermittently, since the network parameters in the fourth monitoring schedule 475 indicate that the probability the ACK is a true ACK is greater than the predetermined value, the fourth monitoring schedule 475 may resume with omitting the further HARQ opportunity for each subsequent PUSCH transmission until an ensuing evaluation PUSCH transmission. In contrast, the second monitoring schedule 425 maintains the monitoring of the further HARQ opportunity for each subsequent PUSCH transmission.

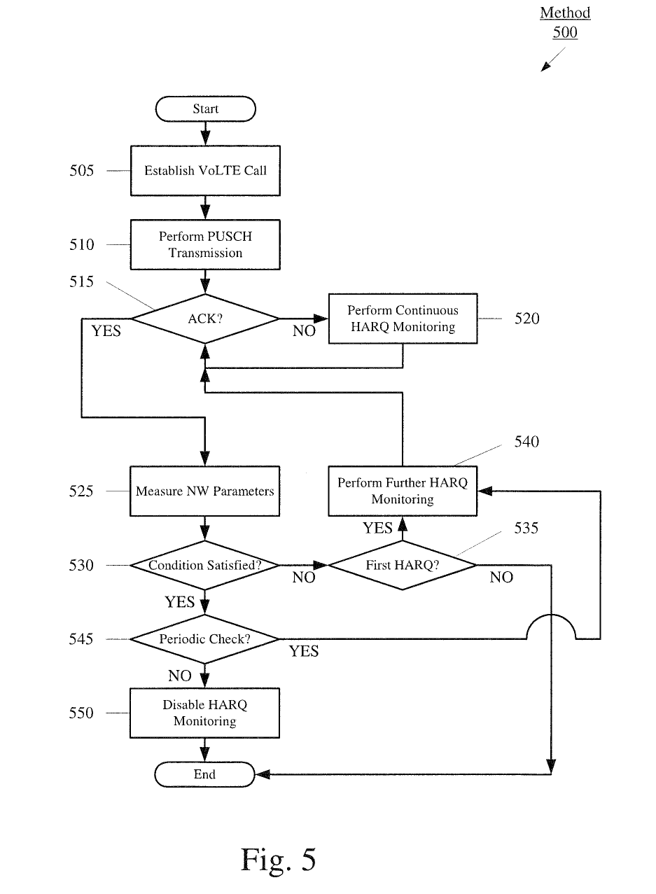

FIG. 5 shows a method for dynamically selecting a monitoring schedule. The method 500 relates to how the UE 110 determines a monitoring schedule to be used based on a response from the LTE-RAN 122 from a PUSCH transmission and based on network parameters when the response is an ACK. The method 500 will be described with regard to the network arrangement 100 of FIG. 1 and the UE 110 of FIG. 3.

In 505, the UE 110 establishes a VoLTE call. As described above, the UE 110 may execute the VoLTE application 335 using a connection to the LTE-RAN 122 via the eNB 122A. Using the IMS 150 and the various connections throughout the network arrangement 100 (e.g., dedicated bearer establishment), the VoLTE call may be established between the UE 110 and a further UE. In 510, the UE 110 performs a PUSCH transmission. For example, the PUSCH transmission during the VoLTE call may be for a talk state in which audio received from the user is packaged for transmission. In performing the PUSCH transmission, it may be assumed that the UE 110 has already transmitted a request for an uplink grant and the LTE-RAN 122 has issued an uplink grant which was decoded in a PDCCH transmission (e.g., in a first subframe of a frame according to the CDRX cycle).

In 515, the UE 110 determines whether the response from the PUSCH transmission is an ACK or a NACK in the first HARQ opportunity. As noted above, with an 8 ms or 8 subframe period between HARQ opportunities with the responses being between the HARQ opportunities in FDD (whereas a 10 ms or 10 subframe period between HARQ opportunities with the responses being between the HARQ opportunities is used in TDD), the first HARQ opportunity may be 4 ms or 4 subframes from the PUSCH transmission. If the response from the LTE-RAN 122 is a NACK, the UE 110 continues the method 500 to 520. In 520, the UE 110 performs continuous HARQ monitoring at each opportunity (every 8 ms or 8 subframes from previous HARQ monitoring opportunity) until an ACK is received. At each HARQ monitoring opportunity, the LTE-RAN 122 may provide a further response. With further NACKS, the HARQ functionality may be used in performing retransmissions until the LTE-RAN 122 transmits an ACK for the PUSCH transmission. Accordingly, the method 500 may return to 515 until the ACK is received. In this manner, the monitoring schedule 400 of FIG. 4A may be utilized.

If the response from the LTE-RAN 122 is an ACK, the UE 110 continues the method 500 from 515 to 525. In 525, the LTE-RAN 122 measures network parameters associated with a probability that the ACK is a true ACK. As described above, the network parameters may include a BLER value, a downlink SNR, a Doppler value, a TTI-B enable/disable, and a power headroom value. It is noted that the network parameters may be a current measured value or an average value over time. For example, the TTI-B may be enabled or disabled and the current value may be the only relevant value. In another example, the BLER value may be an average value measured over a period of time. Thus, the BLER value may be tracked for data transmissions that have occurred over the LTE network connection for a period of time prior to the current PUSCH transmission to which the ACK is received.

In 530, the UE 110 determines whether the conditions associated with the network parameters have been satisfied. If the network parameters that are monitored indicate that the probability that the ACK is a true ACK is below a predetermined value, the UE 110 continues the method 500 to 535. In 535, the UE 110 determines whether the ACK is associated with a first HARQ opportunity for the PUSCH transmission. The relevance of this operation will be described below. As the ACK is associated with the first HARQ opportunity for the PUSCH transmission, the UE 110 continues the method 500 to 540. In 540, the UE 110 performs a further HARQ monitoring to verify that the ACK is a true ACK (or remains an ACK). Subsequently, the UE 110 returns the method 500 to 515.

In returning to 515, the UE 110 may perform the further HARQ opportunity. Specifically, given the network conditions based on the network parameters, the ACK may be a false positive. Thus, a second pass through 515 may result in a NACK being received. Accordingly, the UE 110 may perform 520. However, if the ACK is verified, the UE 110 may continue to 525, 530, and 535. In this pass through 535, the ACK being verified may be associated with the further HARQ opportunity. As the further HARQ opportunity has already been performed, the method 500 may end. In this manner, the monitoring schedule 425 may be used.

Returning to 530, if the conditions of the network parameters indicate that the probability that the ACK is a true ACK is greater than the predetermined value, the UE 110 continues the method 500 to 545. In 545, the UE 110 determines whether the PUSCH transmission corresponds to a periodic check or an evaluation transmission. As described above, the evaluation transmission may be based on an intermittent basis such as every 20^{th} uplink transmission.

If the PUSCH transmission is not an evaluation transmission, the UE 110 continues the method 500 to 550. In 550, the UE 110 disables or omits the further HARQ monitoring opportunity. As the probability that the ACK is a true ACK is greater than the predetermined value or minimum threshold, the UE 110 may omit the further HARQ opportunity to further conserve power. In this manner, the monitoring schedule 450 may be used. If the PUSCH transmission is an evaluation transmission, the UE 110 returns the method 500 to 540.

The exemplary embodiments provide a device, system, and method of performing further HARQ opportunities in a dynamic manner such that a UE adaptively selects a monitoring schedule based on factors including a response from the LTE-RAN for a PUSCH transmission and, if the response is an ACK, network parameters indicative of a probability that the ACK is a true ACK. When the response is a NACK, the UE may utilize a first monitoring schedule in which the UE performs continuous monitoring at each HARQ opportunity until an ACK is received. When the response is an ACK and when the network parameters indicate the probability is below a predetermined value, the UE may utilize a second monitoring schedule in which the UE monitors a further HARQ opportunity. When the response is an ACK and when the network parameters indicate the probability is above a predetermined threshold, the UE may utilize a third monitoring schedule in which the UE omits monitoring a further HARQ opportunity. When the response is an ACK, when the network parameters indicate the probability is above a predetermined threshold, and the PUSCH transmission is an evaluation transmission, the UE may utilize a fourth monitoring schedule in which the UE monitors a further HARQ opportunity only for this PUSCH transmission then resumes with the third monitoring schedule.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. In a further example, the exemplary embodiments of the above described method may be embodied as a program containing lines of code stored on a non-transitory computer readable storage medium that, when compiled, may be executed on a processor or microprocessor.

It will be apparent to those skilled in the art that various modifications may be made in the present invention, without departing from the spirit or the scope of the invention. Thus, it is intended that the present invention cover modifications and variations of this invention provided they come within the scope of the appended claims and their equivalent.

What is claimed is:

1. A method, comprising:
at a user equipment (UE) configured to control an operation of a transceiver, the transceiver configured to enable the UE to establish a connection with a Long Term Evolution (LTE) network, the user equipment and the LTE network configured with and utilizing a Connected Discontinuous Reception (CDRX) functionality:
receiving a response from the LTE network for an uplink transmission;
when the response is an acknowledgement (ACK), determining whether a value of a network parameter associated with the connection with the LTE network satisfies a predetermined threshold; and
when the network parameter satisfies the predetermined threshold, omitting a monitoring opportunity to verify that the ACK is a true ACK.

2. The method of claim 1, wherein the network parameter is a block error rate (BLER) value, a downlink signal to noise ratio (SNR), a Doppler value, a transmission time interval (TTI) bundling (TTI-B) value, a power headroom value, or a combination thereof.

3. The method of claim 2, wherein the predetermined threshold for the BLER value is a maximum of 10%.

4. The method of claim 2, wherein the predetermined threshold for the downlink SNR is a minimum value, wherein the predetermined threshold for the Doppler value is a maximum value, wherein the predetermined threshold for the TTI-B value is a disabled value, and wherein the predetermined threshold for the power headroom value is a minimum value.

5. The method of claim 1, further comprising:
determining a time period since the network parameter was last measured; and
when the time period is greater than a predetermined amount, monitoring the network parameter to update the value of the network parameter.

6. The method of claim 5, wherein the time period is when thirty-two or sixty-four uplink transmissions have been performed.

7. The method of claim 1, further comprising:
when the response is a negative acknowledgement (NACK), continuously performing the monitoring opportunity until the response is an ACK.

8. The method of claim 1, further comprising:
when the network parameter fails the predetermined threshold, performing the monitoring opportunity to verify that the ACK is a true ACK.

9. The method of claim 1, further comprising:
when the network parameter satisfies the predetermined threshold, determining whether the uplink transmission qualifies as an evaluation transmission; and
when the uplink transmission qualifies as the evaluation transmission, performing the monitoring opportunity to verify that the ACK is a true ACK.

10. The method of claim 1, wherein the UE is performing a voice over LTE (VoLTE) call.

11. A user equipment, comprising:
a transceiver configured to enable the user equipment to establish a connection with a network, the user equipment and the network configured with and utilizing a discontinuous reception functionality; and
a processor configured to control an operation of the transceiver by:
receiving a response from the network for an uplink transmission;
when the response is an acknowledgement (ACK), determining whether a value of a network parameter associated with the connection with the network satisfies a predetermined threshold; and
when the network parameter satisfies the predetermined threshold, omitting a monitoring opportunity to verify that the ACK is a true ACK.

12. The user equipment of claim 11, wherein the network parameter is a block error rate (BLER) value, a downlink signal to noise ratio (SNR), a Doppler value, a transmission time interval (TTI) bundling (TTI-B) value, a power headroom value, or a combination thereof.

13. The user equipment of claim 12, wherein the predetermined threshold for the BLER value is a maximum of 10%.

14. The user equipment of claim 12, wherein the predetermined threshold for the downlink SNR is a minimum value, wherein the predetermined threshold for the Doppler value is a maximum value, wherein the predetermined threshold for the TTI-B value is a disabled value, and wherein the predetermined threshold for the power headroom value is a minimum value.

15. The user equipment of claim 11, wherein the processor is configured to control the operation of the transceiver by:
determining a time period since the network parameter was last measured; and
when the time period is greater than a predetermined amount, monitoring the network parameter to update the value of the network parameter.

16. The user equipment of claim 15, wherein the time period is when thirty-two or sixty-four uplink transmissions have been performed.

17. The user equipment of claim 11, wherein the processor is configured to control the operation of the transceiver by:
when the response is a negative acknowledgement (NACK), continuously performing the monitoring opportunity until the response is an ACK.

18. The user equipment of claim 11, wherein the processor is configured to control the operation of the transceiver by:
when the network parameter fails the predetermined threshold, performing the monitoring opportunity to verify that the ACK is a true ACK.

19. The user equipment of claim 11, wherein the processor is configured to control the operation of the transceiver by:
when the network parameter satisfies the predetermined threshold, determining whether the uplink transmission qualifies as an evaluation transmission; and
when the uplink transmission qualifies as the evaluation transmission, performing the monitoring opportunity to verify that the ACK is a true ACK.

20. An integrated circuit, comprising:
input circuitry configured to receive a response from a Long Term Evolution (LTE) network for an uplink transmission via a connection established with the LTE network;
processing circuitry configured to perform a Connected Discontinuous Reception (CDRX) functionality, wherein, when the response is an acknowledgement (ACK), the processing circuitry is configured to determine whether a value of a network parameter associated with the connection with the LTE network satisfies a predetermined threshold, and when the network parameter satisfies the predetermined threshold, the processing circuitry is configured to enter a lower power state and omit a monitoring opportunity to verify that the ACK is a true ACK.
